(19) United States
(12) Patent Application Publication
(10) Pub. No.: US 2006/0237205 A1
(43) Pub. Date: Oct. 26, 2006

(54) Mode selector mechanism for an impact driver

(75) Inventors: Khiam Keong Sia, Kowloon (HK); Raymond Wai Man Wong, Vaucluse (AU); King Yu Poon, Dongguan City (CN); Yanjun Zhang, Dongguan City (CN); Liguo Ma, Dongguan City (CN)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/113,106

(22) Filed: Apr. 21, 2005

(51) Int. Cl. B23B 45/16

(52) U.S. Cl. 173/48; 173/128; 173/216

(57) ABSTRACT

A mode selector mechanism is provided for a rotary power tool for selecting between an impact mode and a drill mode. The power tool includes a housing, a motor oriented in the housing, an input shaft and an output shaft both rotationally mounted in the housing. An impact mechanism connects the input shaft to the output shaft for imparting a rotary impact to the output shaft when the torque load exceeds a predetermined torque capacity of the impact mechanism. A stopping member is shiftable by a user between a first orientation that permits the impact mechanism to operate in the impact mode and a second orientation that prevents a coupler of the impact mechanism from retracting, thus maintaining the connection of the input shaft and the output shaft in the drill mode.

### BACKGROUND

The invention relates generally to a rotary power tool with a mode selector mechanism, and more particularly to an impact driver with a mode selector mechanism for selecting between an impact mode and a drill mode.

Impact drivers are well known in the art of power tools for providing high torque rotary motion. Impact drivers may be powered by alternating current, direct current, pneumatics or hydraulics. An exemplary prior art impact driver is disclosed in U.S. Pat. No. 6,223,834, which discloses an alternating current powered, corded impact driver, which is incorporated by reference herein.

Impact drivers typically include an impact mechanism for providing an increased output torque upon experiencing a load torque that exceeds a predetermined torque of the impact mechanism. The predetermined torque of the impact mechanism is defined by a biasing member incorporated within the mechanism. Upon experiencing a load torque that exceeds this predetermined torque, an output shaft of the impact driver rotates at a speed less than that of an input shaft. The inconsistent speeds of the input and output shafts cause the impact mechanism to impart a rotary impact to the output shaft providing a torque to the output shaft that exceeds the torque limit of the impact mechanism. Rotary impact mechanisms of this type permit a power tool to provide a torque that far exceeds the permissible torque of the motor and gear box or transmission of the impact driver. Thus, a high torque rotary output is provided from a power tool while minimizing the overall size and weight of the power tool and its associated components.

Accordingly, impact drivers are appealing to various users due to the high output torque provided, in a relatively compact size and low weight power tool. Further, due to the rotary impact mechanism, the torque imparted to the hand or wrist of the user is much less than the torque provided at the output of the tool, thus providing a relatively safe and ergonomic high torque operation.

Operations that require a high torque rotary output from a power tool may include tightening and loosening of bolts and screws into wood, concrete and other construction materials. Impact drivers may also be used to tighten and loosen machine screws and nuts in various assembly and disassembly operations. However, conventional impact drivers are not universal as a rotary tool because of difficulties associated with using impact drivers in drilling operations. Specifically, utilization of a conventional impact driver in a drilling operation may inadvertently provide a rotary impact and associated torque to a drill bit that exceeds the load capabilities of the drill bit. This difficulty is also applicable to smaller driver bits that are utilized in low torque operations. Likewise, conventional impact drivers are not generally preferred for general purpose driving applications where smooth torque is desired and a torque limiting clutch is used. Therefore, conventional impact drivers are typically utilized specifically for high torque applications only and other rotary tools are commonly required for low torque operations or operations where smooth torque is desired.

Prior art impact drivers with a mode selector generally have a mechanism that extends through the gear box and impact mechanism for selecting an impact mode or a drill mode. However, such prior art drivers are relatively complex with many machined components that require complex manufacturing processes to manufacture and assemble, thus resulting in a relatively high cost power tool. By contrast, one goal of the present invention is to provide a simplified rotary power tool with a mode selector mechanism for selecting between an impact mode and a drill mode that is competitive in cost due to a simplified design and is effective in both a drill mode and an impact mode for providing flexibility to a user.

### BRIEF SUMMARY

A mode selector mechanism is described that allows a user to select either an impact mode or a drill mode. The impact mode provides torque pulses to the output shaft when high torque loads are experienced. The drill mode provides generally smooth torque to the output shaft. A clutch that limits the torque to the output shaft may also be used. The mode selector mechanism includes a stopping member that prevents the impact mechanism from disengaging in the drill mode but allows the impact mechanism to disengage and reengage in the impact mode. Additional details and advantages are described below.

### BRIEF DESCRIPTION OF SEVERAL VIEWS OF THE DRAWINGS

The invention may be more fully understood by reading the following description in conjunction with the drawings, in which:

FIG. 1 is a side elevation partial section view of one embodiment of an impact driver;

FIG. 2 is a side elevation section view of an impact mechanism, illustrating the impact mechanism in a coupled orientation in an impact mode;

FIG. 3 is another side elevation section view of the impact mechanism of the impact driver of FIG. 2, illustrating an uncoupled orientation in the impact mode;

FIG. 4 is a perspective view of the impact mechanism illustrated in FIG. 2;

FIG. 5 is a perspective view of the impact mechanism illustrated in FIG. 3;

FIG. 6 is a perspective view of the impact mechanism of FIGS. 2 and 3, illustrated in another orientation;

FIG. 7 is a side elevation section view of the impact mechanism of FIG. 2, illustrated in a drill mode;

FIG. 8 is a cross section view of the mode selector mechanism of the impact driver of FIG. 2, taken along section line 8-8, illustrating the mode selector mechanism in the impact mode;

FIG. 9 is a cross section view of the mode selector mechanism of the impact driver of FIG. 2, taken along section line 9-9 in FIG. 7, illustrating the mode selector mechanism in the drill mode;

FIG. 10 is a cross section view of a rotary cap of the mode selector mechanism of the impact driver of FIG. 2;

FIG. 11 is a cross section view of an alternative embodiment mode selector mechanism, illustrated in an impact mode;

FIG. 12 is a cross section view of the mode selector mechanism of FIG. 11, illustrated in a drill mode;

FIG. 13 is a cross section view of a rotary cap of the mode selector mechanism of FIG. 11;

FIG. 14 is a cross section view of another embodiment of an impact mechanism;

FIG. 15 is a perspective view of the exterior of the impact mechanism;

FIG. 16 is a perspective view of the internal components of the impact mechanism of FIG. 14;

FIG. 17 is an enlarged perspective view of a hammer block, stopping mandril and associated components of the impact mechanism of FIG. 14;

FIG. 18 is an exploded view of the impact mechanism of FIG. 14;

FIG. 19 is an exploded view of the hammer block, input shaft and associated components of the impact mechanism of FIG. 14;

FIG. 20 is a rear perspective view of the stopping mandril of the impact mechanism of FIG. 14;

FIG. 21 is a rear view of the stopping mandril of the impact mechanism of FIG. 14;

FIG. 22 is a front perspective view of a clutch cap of the impact mechanism of FIG. 14;

FIG. 23 is a partially sectioned perspective view of the impact mechanism of FIG. 14, illustrating an impact mode with the hammer block engaged with the output shaft;

FIG. 24 is a partially sectioned perspective view of the impact mechanism of FIG. 14, illustrating the impact mode with the hammer block disengaged from the output shaft;

FIG. 25 is a partially sectioned perspective view of the impact mechanism of FIG. 14, illustrating a driver mode with a clutch at a low torque setting; and

FIG. 26 is a electrical circuit diagram of an electronic clutch.

### DETAILED DESCRIPTION

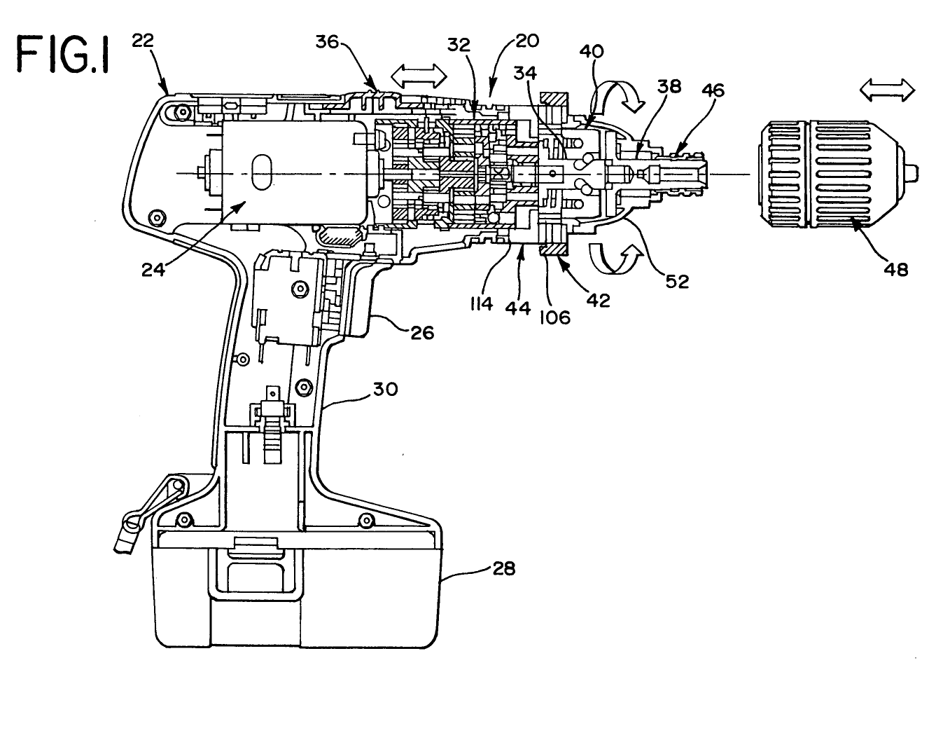

With reference now to FIG. 1, one embodiment of a rotary power tool is illustrated, characterized as an impact driver and referenced generally by numeral 20. The impact driver 20 includes a housing 22 with a motor 24 oriented therein. The motor 24 is selectively operated by trigger switch 26 for providing power from a power source. The power source is a battery 28 received within a lower portion of a handle 30 of the housing 22. Of course any type of power source may be used with the impact driver 20. The motor 24 drives a gear box 32 that is also oriented within the housing 22 for imparting a reduced rotation to an input shaft 34 that is rotatably mounted within the housing.

The gear box 32 includes three planetary gear sets for providing three stages of gear reduction. The gear box 32 is also shiftable between a high speed and a low speed via a speed selector 36 for selection between three stage and two stage gear reduction. High speed may be desired for high speed, low torque operations, such as drilling, whereas low speed may be desired for low speed, high torque driving operations. The gear box 32 is disclosed with further detail in U.S. Pat. No. 5,339,908, which is incorporated by reference herein. Alternatively, a three speed gear box may be utilized as disclosed in U.S. Pat. No. 6,796,921, which is also incorporated by reference herein.

The impact driver 20 also includes an output shaft 38 rotatably mounted in the housing 22 and partially extending therefrom. The output shaft 38 is connected to the input shaft 34 through an impact mechanism 40 which operates similarly to an impact mechanism of the power tool disclosed in U.S. Pat. No. 6,223,834, which is incorporated by reference herein. The impact mechanism 40 connects the input shaft 34 to the output shaft 38 for imparting a rotary impact to the output shaft 38 when a torque is experienced by the output shaft 38 that exceeds a predetermined torque of the impact mechanism 40. Thus, the impact mechanism 40 acts as a torque responsive coupler for decoupling and recoupling the connection between the input shaft 34 and the output shaft 38 during an impact mode of the impact driver 20. As a result, the impact mode produces pulses of torque at the output shaft 38 as distinguished from generally smooth output torque. Depending on the desired use, the impact mode may or may not also include a limiting torque clutch.

The impact driver 20 includes a mode selector mechanism 42 for permitting a user to select the impact mode or a drill mode. In the drill mode of the impact driver 20, the impact mechanism 40 is prevented from decoupling, thus maintaining the connection between the input shaft 34 and the output shaft 38 and preventing the impact mechanism 40 from imparting a rotary impact to the output shaft 38. Thus, drill mode refers to a mode where generally smooth torque is applied to the output shaft 38. The drill mode may or may not include a torque limiting clutch depending on the desired use. When the drill mode includes a torque limiting clutch, this mode is sometimes referred to as a driver mode, since the clutch makes the drill especially useful for driving screws and the like. In the described embodiment, the impact driver 20 includes an adjustable clutch 44 operably connecting the input shaft 34 to the motor 24 and regulating the torque transmitted therethrough. Clutches are well known in the art of power tools, such as U.S. Pat. No. 5,277,527, which is incorporated by reference herein.

The impact driver 20 provides various tool holders for performing various rotary operations. The output shaft 38 includes a socket 46 extending from the housing 22 for receiving shanks of various bits for performing drilling operations in the drill mode, torque regulated driving operations in the drill mode, or high torque, rotary impact operations in the impact mode. Further, the impact driver 20 includes a conventional chuck 48 releaseably attached to the output shaft 38 for receiving shanks of various sizes of drill bits and driver bits, for similar operations as listed above. However, the socket 46 is preferred for rotary impact operations.

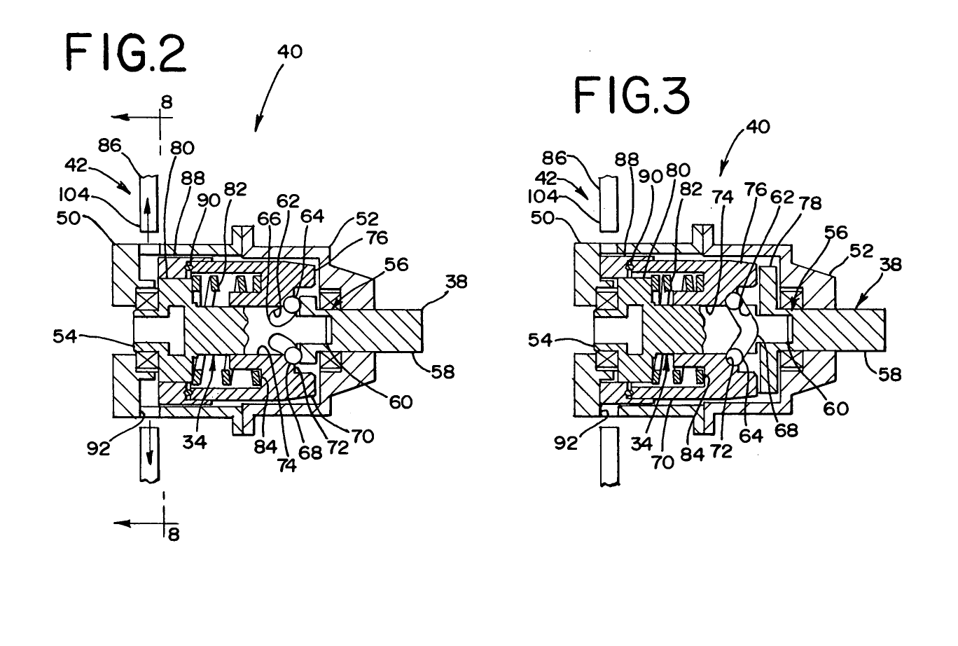

Referring now to FIGS. 2 through 6, one embodiment of the impact mechanism 40 is illustrated in detail. The impact mechanism 40 is housed within a rear housing 50 and a front housing 52. The rear housing 50 and front housing 52 form part of the housing 22 and may be formed integrally with the housing 22 or may be formed separately for assembly purposes, or formed of a separate material. For example a higher strength material may be required for the front housing 52 which may experience wear due to its proximity to the operation of the impact driver 22.

The impact mechanism 40 is similar to conventional impact drivers. The input shaft 34 has a rearward end 54 that is rotatably mounted within the rear housing 50 and is driven by the gear box 32. The input shaft rearward end 54 may include an internal or external spline for rotary engagement with the gear box 32. The output shaft 38 includes a rearward end 56 that is rotatably mounted within the front housing 52 and has a forward end 58 that extends from the front housing 52 and forms part of the tool holder. The input shaft 34 has a forward end 60 that is rotatably mounted within the output shaft rearward end 56 such that the input shaft forward end 60 is bearingly supported within the output shaft rearward end 56 and is rotatable relative thereto.

A first cam configuration is formed about the shank of the input shaft 34 and is defined as a series of cam tracks 62 formed therein, each sized to receive a corresponding ball 64. Although a continuous cam track may be formed about the shank of the input shaft 34, a pair of diametrically opposed cam tracks 62 may be formed therein, each having a range defined by a pair of rearward cam limits 66, and each cam track 62 having a forward cam peak 68.

The impact mechanism 40 includes a hammer block 70 oriented about the shank of the input shaft 34. The hammer block 70 includes a second cam configuration for corresponding with the cam configuration of the input shaft 34. Specifically, the hammer block 70 includes a pair of diametrically opposed longitudinal recesses 72 formed therein adjacent to a central bore 74 of the hammer block through which the shank of the input shaft 34 extends through. The hammer block 70 includes a pair of forward extending projections or pawls 76 for cooperating with a pair of arms 78, which extend radially from the output shaft rearward end 56.

The input shaft 34 includes a collar 80 formed thereabout. The collar 80 has an external diameter greater than that of the shank of the input shaft 34. The impact mechanism 40 includes a biasing member, specifically a compression spring 82 oriented about the shank of the input shaft 34 and received within an annular recess 84 formed within the hammer block 70. The spring 82 cooperates with a forward face of the collar 80 and the annular recess 84 of the hammer block 70 to urge the hammer block 70 such that the ball bearings 64 are translated within the respective cam tracks 62 to the forward cam peaks 68, thus providing engagement of the hammer block pawls 76 with the output shaft arms 78.

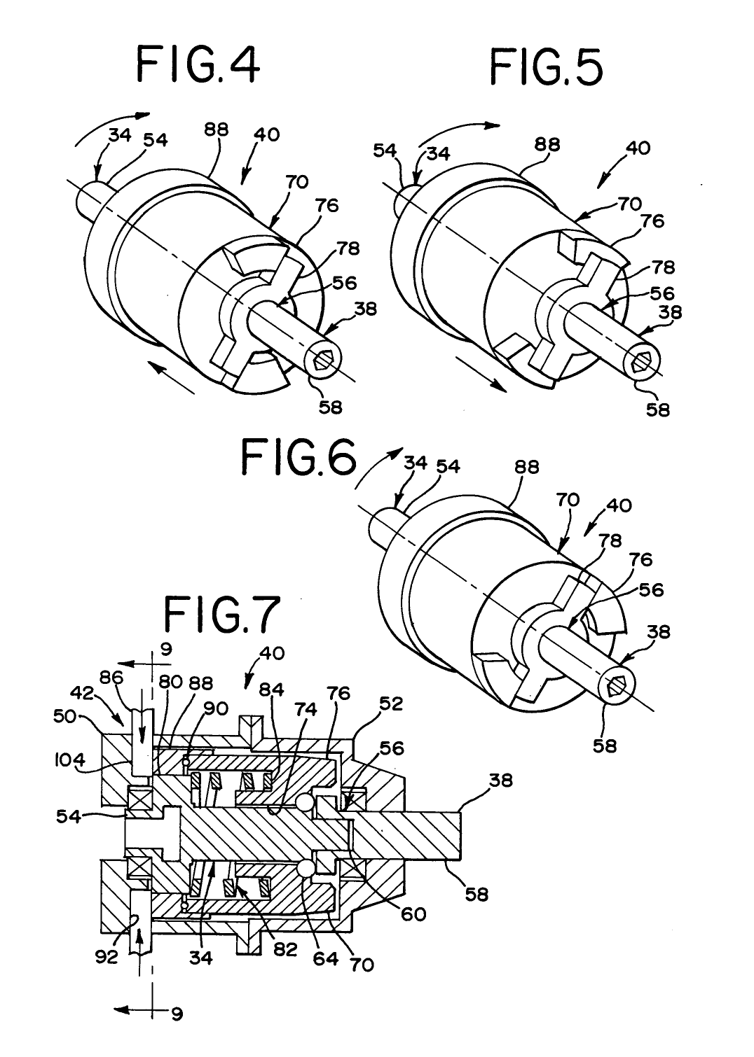

The operation of the impact mechanism 40 will now be described, beginning with reference to FIGS. 2 and 4. As the input shaft 34 is driven in a clockwise direction, as illustrated by the clockwise arrow in FIG. 4, the balls 64 that are received within the cam tracks 62 of the input shaft 34, drive the hammer block 70 in the clockwise direction. The spring 82 urges the hammer block 70 forward during this clockwise rotation such that the hammer block pawls 76 engage the output shaft arms 78 and consequently drive the output shaft 38 in a clockwise direction. The spring 82 provides a forward force to the hammer block 70, which increases as the hammer block 70 is retracted rearward, thus compressing the spring 82 further. Due to the cam cooperation of the hammer block 70 and the input shaft 34, the hammer block 70 may be retracted rearwardly as a function of torque applied to the hammer block 70 for compressing the spring 82. As the hammer block 70 is retracted rearwardly to a rearmost position, defined by the rearward cam limits 66 of the cam track 62, the torque required to retract the hammer block 70 increases as the compression spring 82 is compressed. The impact mechanism 40 is designed such that the maximum torque required to retract the hammer block 70 does not exceed the torque capacity of the gear box 32 or the motor 24.

During an impact driving operation, the hammer block 70 continuously drives the output shaft 38 in the clockwise direction until the output shaft 38 experiences a torque that exceeds the maximum torque permitted by the impact mechanism 40. As the output shaft 38 experiences this torque, the output shaft 38 rotates at a speed less than that of the input shaft 34, or the output shaft 38 stalls altogether as the input shaft 34 continues to rotate. Due to the engagement of the hammer block 70 with the output shaft 38, the hammer block 70 also rotates at a speed less than that of the input shaft 34. The rotary orientation of the balls 64 is defined by the rotary orientation of the recesses 72 of the hammer block 70. Thus, as the input shaft 34 continues to rotate relative to the hammer block 70 and the output shaft 38, the balls 64 advance to the rearward cam limits 66 of the cam track 62, as illustrated in FIG. 3, thus urging the hammer block 70 rearward and decoupling the engagement between the hammer block pawls 76 and the output shaft arms 78.

Once the hammer block 70 is fully retracted and disengaged from the output shaft 38, the hammer block 70 rotates with the input shaft 34 such that the hammer block pawls 76 cross over the output shaft arms 78 as illustrated in FIGS. 3 and 5. Once the hammer block pawls 76 completely cross over the output shaft arms 78, the spring 82 urges the hammer block 70 forward again so that it returns to a forward-most orientation corresponding with the balls 64 being advanced to the forward cam peaks 68. This forward-most position of the hammer block 70, subsequent to the cross over, is illustrated in FIG. 6. As the input shaft 34 continues to rotate, the hammer block 70 continues to rotate clockwise until the hammer block pawls 76 contact the output shaft arms 78 as illustrated with reference again to FIG. 4. The hammer block 70 has a mass such that an impact is imparted from the hammer block 70 to the output shaft 38 as a result of this contact. The impact generates an output torque in the output shaft 38, as a result of the impact, that far exceeds the torque required to decouple the hammer block 70 and the output shaft 38. Accordingly, the impact mechanism 40 provides a high torque output relative to the torque capabilities of the motor 24 and gear box 32, thus minimizing the overall size and weight of the impact driver 22.

The hammer block 70 is generally symmetrical in design, and the output shaft 38 is also generally symmetrical as well. The cam tracks 62 are each provided with rearward cam limits 66 on either side of the forward cam peaks 68 so that the impact mechanism 40 can operate as described above in either rotational direction, clockwise or counterclockwise. Therefore, the impact driver 20 can impart an impact driving operation in either rotational direction for providing the impact for both tightening and loosening. Upon experiencing a high torque load, the impact mechanism 40 may repetitively apply intermittent impacts upon the output shaft until the torque load is overcome or the user discontinues the rotary operation of the impact driver 20.

Conventional impact drivers are relatively costly and are relatively limited in use because the impact feature may damage bits that are used for low torque applications, such as drilling. Therefore, the impact driver 22 provides the mode selector mechanism 42 for permitting the user to select either the impact mode or the drill mode.

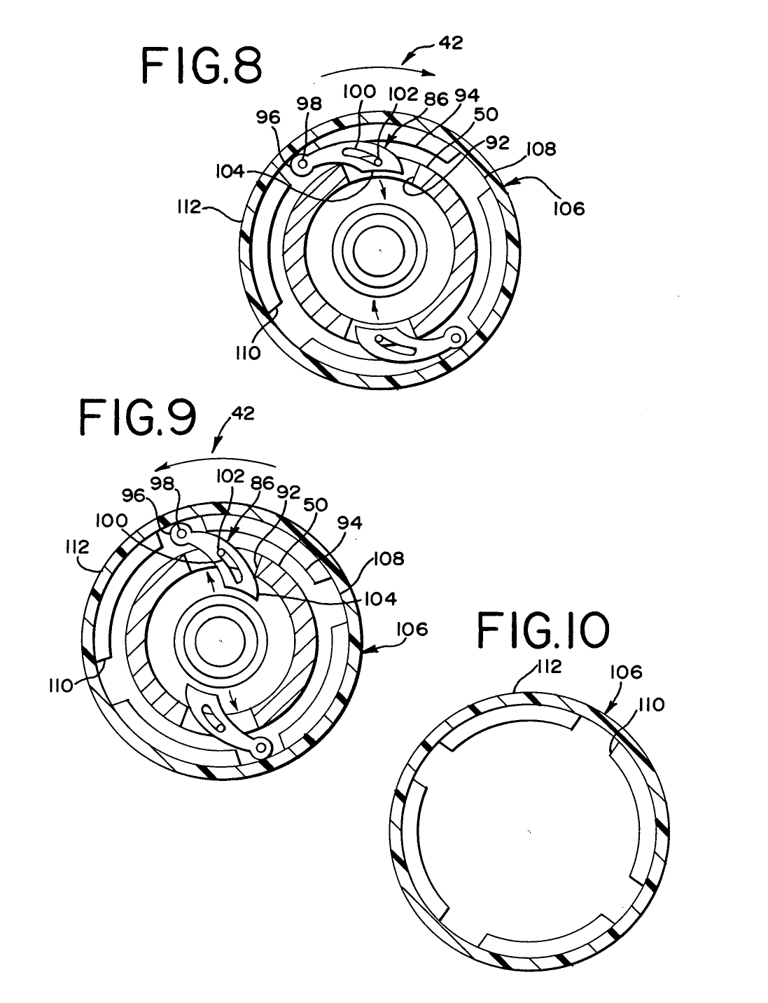

Referring to FIG. 7, the impact mechanism 40 is illustrated in the drill mode. The mode selector mechanism 42 includes a stopping member for preventing the impact mechanism 40 from providing the impact to the output shaft 38. The stopping member is defined as a pair of diametrically opposed arcuate arms 86 that are shiftable by the user to a first orientation, as illustrated in FIGS. 2 and 3, wherein the hammer block is free to move axially in the impact mode. The stopping arms 86 are also shiftable to a second orientation for preventing the hammer block 70 from retracting, as illustrated in FIG. 7. By preventing the hammer block 70 from retracting, the hammer block 70 and the output shaft 38 remain engaged regardless of the torque load. Therefore, the connection between the hammer block 70 and the output shaft 38 is maintained in the drill mode, preventing the hammer block 70 from imparting a rotary impact to the output shaft 38. Although any number of stopping arms could be used, the described embodiment includes a pair to evenly support the rearward axial load of the hammer block 70.

When a torque load is applied to the output shaft 38, the stopping arms 86 interfere with the path of travel of the hammer block 70. When the output shaft 38 experiences a torque load in the drill mode that exceeds the predetermined torque of the impact mechanism 40, the rearward travel of the hammer block 70 is prevented by the stopping arms 86. As the torque applied to the hammer block 70 urges the hammer block 70 rearward, a force is applied to the stopping arms 86. In order to reduce friction in the cooperation between the hammer block 70 and the stopping arms 86, the hammer block 70 includes a rearward supporting ring 88 affixed thereto by a thrust bearing 90. Thus, as the supporting ring 88 is pressed against the stopping arms 86, the hammer block 70 is free to rotate relative to the supporting ring 88 and thrust support is provided to the hammer block 70 through the thrust bearing 90, thus minimizing friction therebetween.

Referring again to FIG. 2, the impact driver 20 may be shifted to the drill mode when the hammer block 70 is oriented in a forward orientation. When the hammer block 70 is retracted rearward, as in FIG. 3, the stopping arms 86 may not be shifted into the path of travel of the hammer block 76. Thus, if the impact mechanism 40 is in the cross over orientation of FIG. 3, the hammer block 70 must be returned to a forward orientation before the drill mode may be selected.

Referring now to FIGS. 8 through 9, the mode selector mechanism 42 is illustrated in further detail. The rear housing 50 includes a pair of apertures 92 formed within the sidewalls for permitting the stopping arms 86 to shift therethrough into the path of travel of the hammer block 70. The mode selector mechanism 42 includes an annular ring 94 that is pivotally affixed to the rear housing 50. The annular ring 94 acts as an actuation member and is shiftable by the user for selecting the impact mode and the drill mode. Each stopping arm 86 includes a first end 96 that is pivotally connected to the annular ring 94 by a first pin 98. An arcuate slot 100 is formed within an intermediate region of the arcuate stopping arm 86. A longitudinal second pin 102 is affixed to the rear housing 50 and received within the arcuate slot 100. Each stopping arm 86 also includes a second end 104 for translation into and out of an axial path of travel of the hammer block 70.

The operation of the mode selector mechanism 42 is best illustrated with reference to FIGS. 8 and 9, which are section views of the mode selector mechanism 42, taken from FIGS. 2 and 7 respectively. Referring specifically to FIG. 8, the annular ring 94 is oriented in a first orientation wherein the stopping arm second ends 104 are retracted from the rear housing 50. A first orientation of the annular ring 94, as illustrated in FIG. 8 illustrates the selection of the impact mode of the impact driver 20. When the drill mode of the impact driver 20 is desired, the user shifts the annular ring 94 in a clockwise direction, as illustrated by the clockwise arrow in FIG. 8.

Referring now to FIG. 9, as the annular ring 94 is rotated relative to the rear housing 50, the stopping arm first ends 96 are each rotationally displaced about the rear housing 50. Concurrently, the intermediate regions of the stopping arms 86 translate such that the arcuate slots 100 each slide about the corresponding second pin 102, thus extending the stopping arm second ends 104 each within the rear housing 50 and within the path of travel of the hammer block 70. To return the impact driver 20 to an impact mode, the annular ring 94 is rotated in a counterclockwise direction as indicated by the counterclockwise arrow in FIG. 9, thus shifting the stopping arm second ends 104 out of the path of travel of the hammer block 70 as illustrated with reference again to FIG. 8.

The mode selector mechanism 42 also includes a rotary cap 106 as illustrated in cross section in FIG. 10. The annular ring 94 includes a radial array of lugs 108 extending thereabout and the rotary cap 106 includes a corresponding series of internal axial slots 110 that are sized to receive the lugs 108 for affixing the mode selector rotary cap 106 to the annular ring 94. The rotary cap 106 includes an external grip surface 112 to be gripped by the user for rotating the rotary cap 106 and the annular ring 94 for selecting the desired mode. Further, the rotary cap external grip surface 112 extends over the stopping arms 86 and the apertures 92 formed within the rear housing 50 for enclosing the mode selector mechanism 42.

In summary, the impact driver 20 includes a mode selector mechanism 42 that is shiftable by the user between the drill mode and the impact mode by rotation of the mode selector rotary cap 106. The clutch 44 includes a rotary cap 114 as well for adjustment of the torque permitted by the clutch 44. Thus, the described embodiment provides a mode selector mechanism that converts an impact mechanism into drill mode by interrupting the path of travel of the hammer block 70. This feature is simplified as compared to prior art mode selector mechanisms that connect the input shaft to the output shaft. As a result, fewer components are needed, many of which require machining, thereby reducing the cost associated with manufacturing the components and the assembly of the driver.

Referring now to FIGS. 11 through 13, an alternative embodiment mode selector mechanism 116 is illustrated. The mode selector mechanism 116 includes a single rotary cap 118 for selecting the desired mode, impact or drill, of the impact mechanism 40 and for concurrently adjusting the torque of the clutch 44. The rotary cap 118 includes a rearward region 120 that is pivotally connected to the housing 22 and cooperates with the clutch 44. The rearward region 120 of the rotary cap 118 operates like the cap of the torque adjustment device described in U.S. Pat. No. 5,277,527.

Unlike the mode selector rotary cap 106 shown in FIGS. 8-10, the rotary cap 118 is not directly connected to the annular ring 94. Rather, an internal region of the rotary cap 118 includes a pair of first internal annular steps 122 extending radially inward and a pair of second internal annular steps 124 extending radially inward further than the first steps 122. Each first step 122 and each second step 124 are formed within the rotary cap 118 for engagement with a corresponding lever 126 extending radially from each stopping arm first end 96. A recess 128 is oriented between each first step 122 and the respective second step 124 for receiving the lever 126 of the respective stopping arm 86.

Referring specifically to FIG. 11, the lever 126 of the stopping arm 86 extends radially outward in the impact mode of the impact mechanism. In this orientation of the lever 126, it is received within the corresponding recess 128. As the rotary cap 118 is rotated clockwise as illustrated by the clockwise arrow in FIG. 11, each first step 122 shifts the respective lever 126 clockwise. As the levers 126 are shifted clockwise, the stopping arm first ends 96 are shifted clockwise and the annular ring 94 is concurrently rotated clockwise about the rear housing 50. As the stopping arm first ends 96 and the annular ring 94 are shifted clockwise, the arcuate slots 100 slide about the respective second pins 102 as the stopping arm second ends 104 are shifted into the path of travel of the hammer block 70.

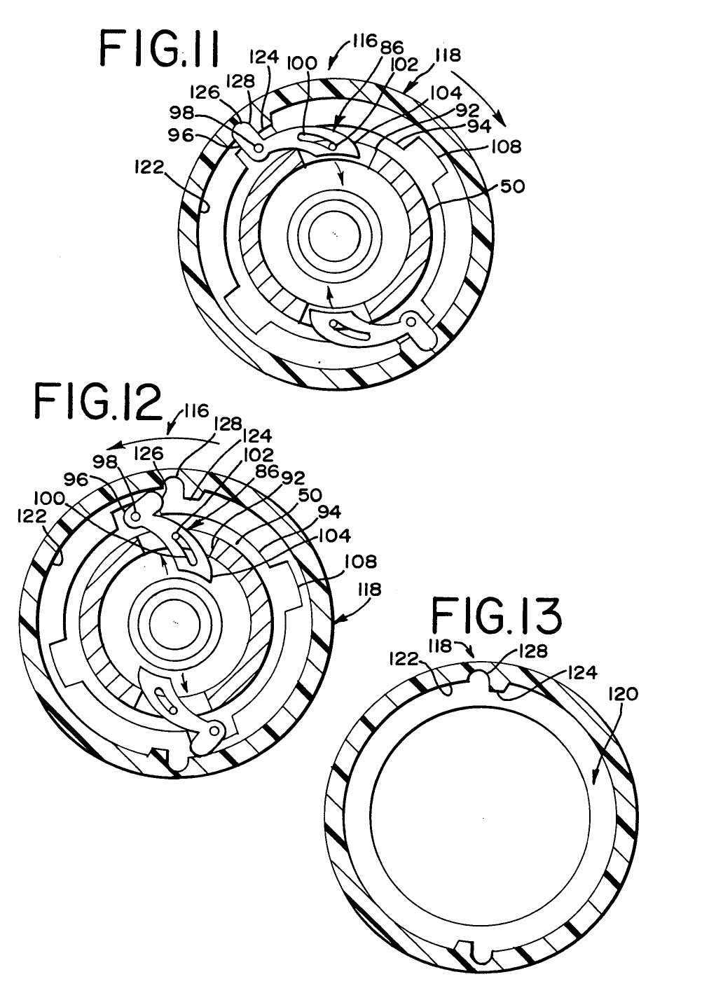

Referring now to FIG. 12, upon shifting the mode selector mechanism 116 into the drill mode, the levers 126 extend only partially radially outward for continuous contact with the annular first step 122 through a plurality of rotational positions of the rotary cap 118.

To shift the mode selector mechanism 116 from the drill mode to the impact mode, the rotary cap 118 is shifted counterclockwise as indicated by the counterclockwise arrow in FIG. 12. During this counterclockwise rotation, the second steps 124 engage the partially extended levers 126, thus causing the levers 126 to extend into the corresponding recess 128 as the stopping arm first ends 96 and the annular ring 94 are rotated counterclockwise relative to the rear housing 50.

The rotary cap 118 cooperates with the mode selector mechanism 116 and the clutch 44 such that in a first position of the rotary cap 118 as illustrated in FIG. 11, the stopping arms 86 are shifted into the impact mode, and the adjustable clutch provides direct drive from the motor 24 to the input shaft 34. Thus, in the impact mode, the clutch 44 does not idle as a result of the torque load applied to the output shaft 38, bypassing the clutch 44 so that torque load applied to the output shaft 38 affects the impact mechanism 40 without interference from the clutch.

The rotary cap 118 is rotatable to a second position, as illustrated in FIG. 12, wherein the stopping arms 86 are shifted into the rear housing 50, thus disabling the impact mechanism, and the adjustable clutch 44 still provides direct drive from the motor 24 to the input shaft 34 for a drill mode wherein the clutch is bypassed. The rotary cap 118 is rotatable to a plurality of positions as indicated by the clockwise arrow in FIG. 12, where the stopping arms 86 are retained in the drill mode, due to the arcuate length of the first step 122, and the adjustable clutch 44 provides various torque settings within this range of rotation of the rotary cap 118. This alternative embodiment mode selector mechanism 116 permits a user to adjust both the impact mechanism 40 and the clutch 44 without having to adjust more than one rotary cap.

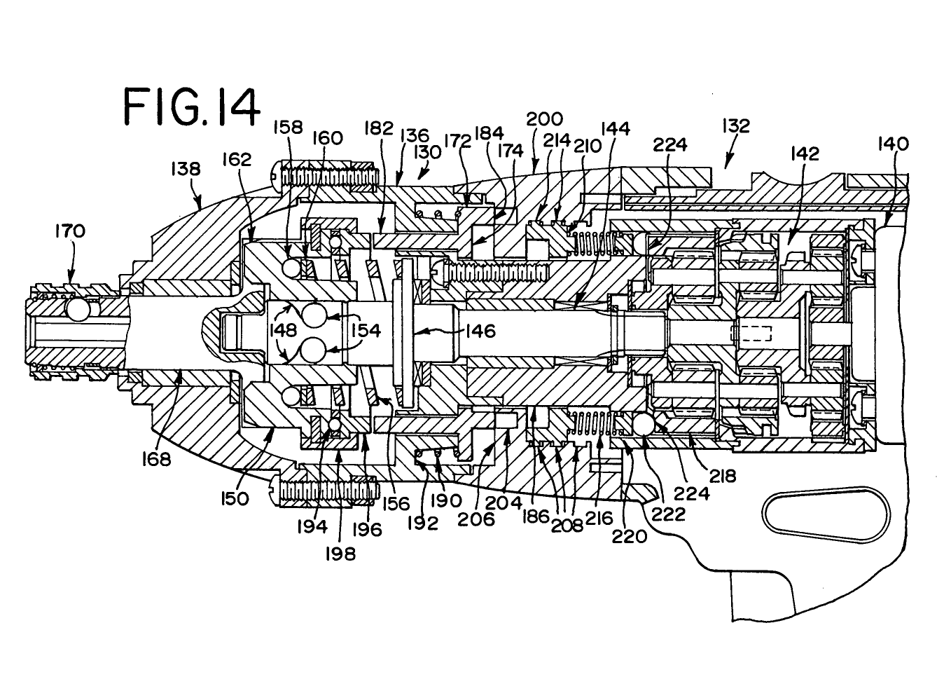

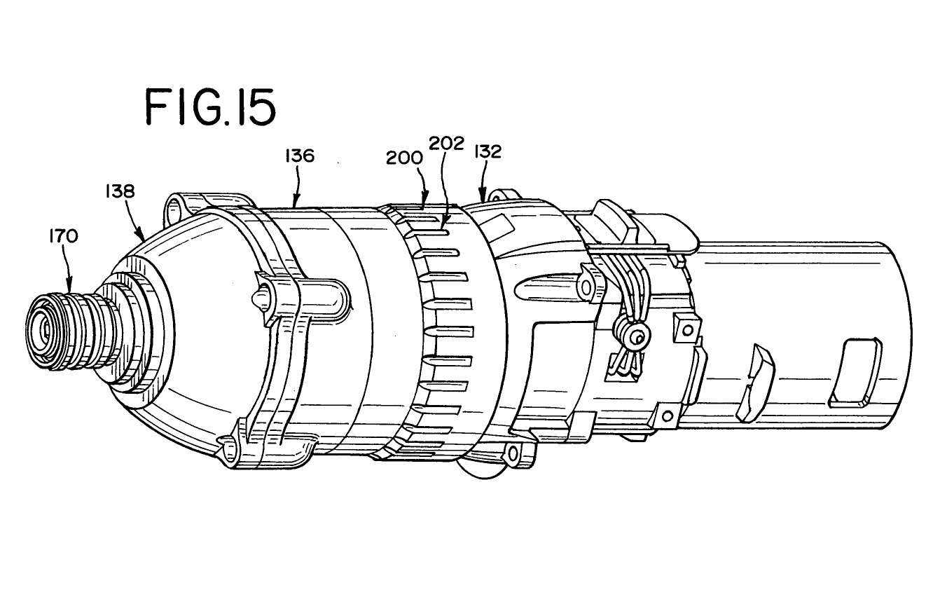

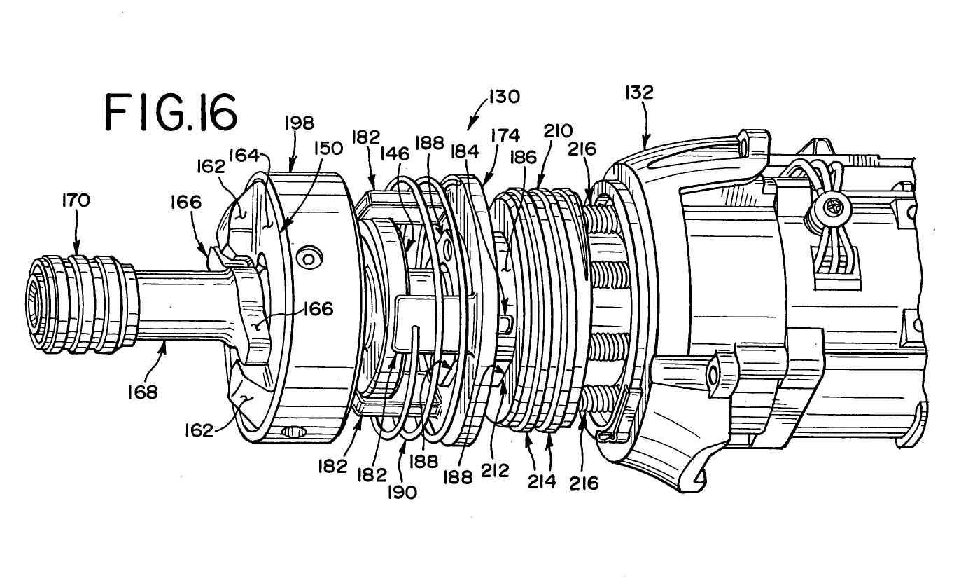

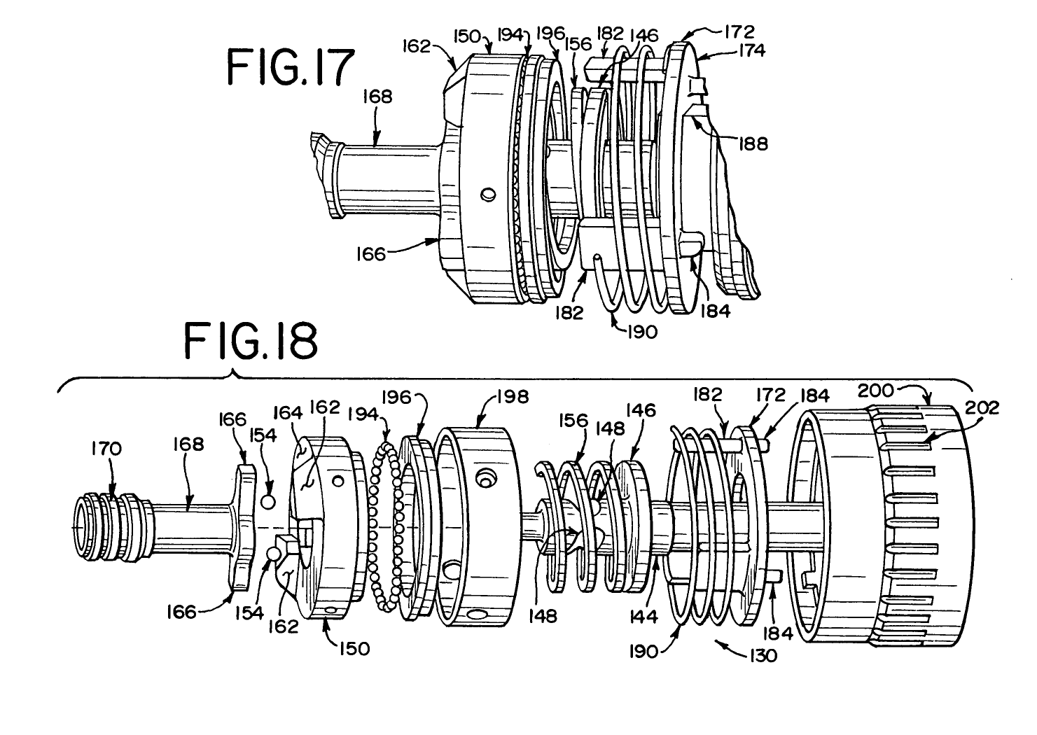

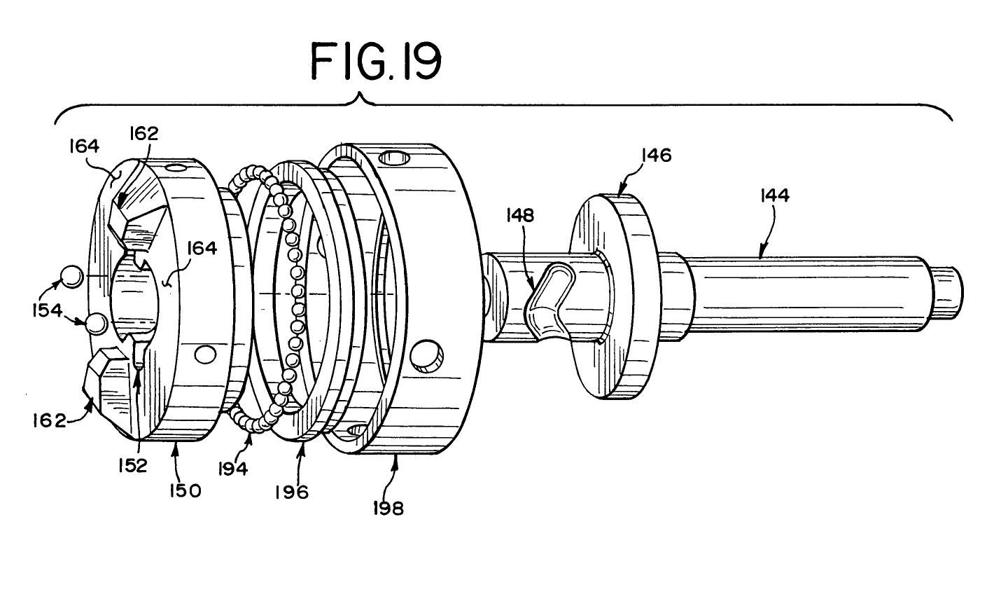

Referring now to FIGS. 14 through 25, another embodiment of a mode selector mechanism 130 is shown. As shown in FIGS. 14 and 15, the impact driver 20 may include a gear box housing 132, a rotary cap 200, a connecting sleeve 136, and a front housing 138. Typically, the impact driver 20 may also include a motor 140 and transmission gears 142 which provide rotational torque to an input shaft 144. The input shaft 144 is restricted from moving axially relative to the gear box housing 132 but may rotate within the housing 132 on a bearing. As further shown in FIGS. 14 and 16 through 19, the input shaft 144 includes a spring retaining plate 146 formed around the diameter of the input shaft 144. At the forward end of the input shaft 144, an impact member 150, or hammer block, is coupled to the input shaft 144 so that the input shaft 144 may drive the impact member 150 rotationally and the impact member 150 may move axially relative to the input shaft 144. Although various coupling arrangements may be used, cam recesses 152 are preferably provided along the inner diameter of the impact member 150 which correspond to cam grooves 148 on the input shaft 144. Balls 154 may be installed within the cam grooves 148 and the cam recesses 152 to couple the input shaft 144 and the impact member 150 together.

The impact member 150 is biased forward by a compression spring 156 which is installed between the spring retaining plate 146 of the input shaft 144 and the impact member 150. Preferably, a series of balls 158 and a thrust washer 160 are provided between the front end of the spring 156 and the impact member 150 to allow rotational movement between the impact member 150 and the input shaft 144 without twisting the spring 156. The impact member 150 includes two pawls 162 that extend axially forward from a front face 164 of the impact member 150. The pawls 162 of the impact member 150 are engageable with two arms 166, or driven portions, that extend radially outward from the output shaft 168. The output shaft 168 is restricted from moving axially relative to the front housing 138 but may rotate within the housing 138 on a bearing. The front end of the output shaft 168 is provided with a socket 170 or other connector for attaching various tools to the output shaft 168.

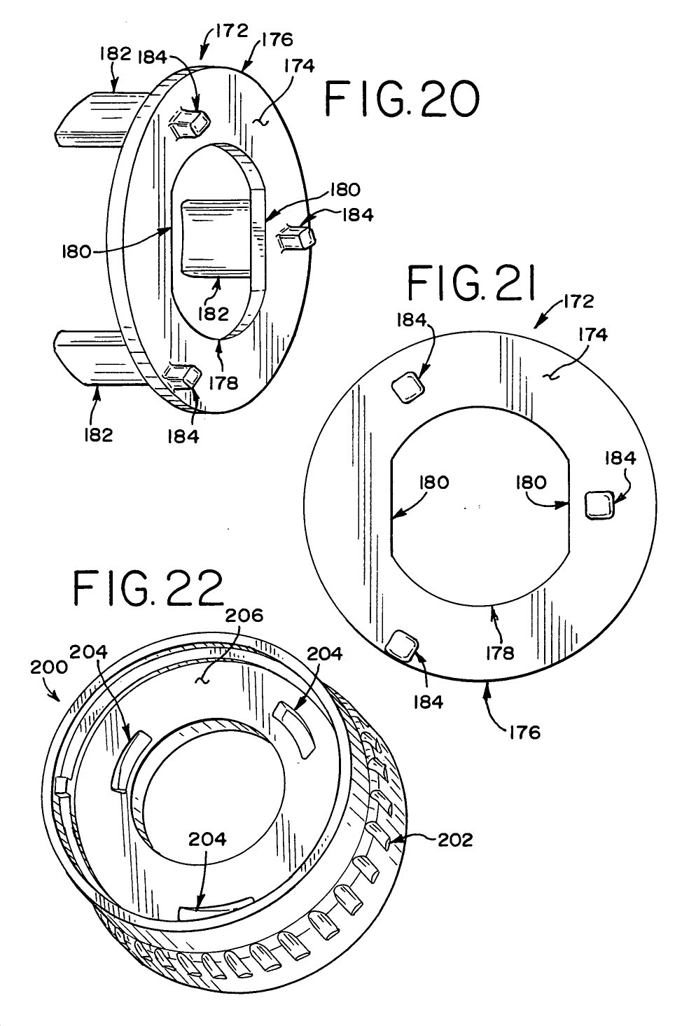

A stopping mandril 172, or stopping member, is also provided to prevent the pawls 162 of the impact member 150 from disengaging from the arms 166 of the output shaft 168. This function will be described in detail further below. As shown in FIGS. 20 and 21, the stopping mandril 172 has a plate 174 with an outer diameter 176 and an inner diameter 178. The inner diameter may have straight sides 180. Thus, as shown in FIG. 16, when the stopping mandril 172 is installed onto the internal housing 186 (which cannot rotate), the straight sides 180 of the stopping mandril 172 engage the straight sides 188 of the internal housing 186 and prevent the stopping mandril 172 from rotating. However, the stopping mandril 172 may move axially on the internal housing 186. Three arms 182 extend axially forward from the plate 174. Three portions 184 extend axially rearward from the plate 174. The three rearward portions 184 may be arranged equally spaced around the plate 174 but with each portion 184 at different radially locations from the axis of rotation. Although the stopping mandril 172 may be made in several ways, one cost effective way to make the stopping mandril 172 is to mold it as a single, integral component.

Referring back to FIGS. 14 and 16 through 19, a spring 190 is installed between the forward side of the stopping mandril plate 174 and a rear internal face 192 of the connecting sleeve 136. Thus, the spring 190 biases the stopping mandril 172 rearward. A thrust bearing 184 and supporting ring 196 are also provided along the rear end of the impact member 150 to allow rotary motion between the stopping mandril arms 182 and the impact member 150 as described further below. The thrust bearing 194 and supporting ring 196 may be retained to the impact member 150 with a collar 198 that is attached to the impact member 150.

As shown also in FIG. 15, a rotary cap 200 is provided between the gear box housing 132 and the connecting sleeve 136. The rotary cap 200, or mode selector, may be rotatably mounted on the impact driver 20 to allow a user to change operating modes and clutch settings by turning the rotary cap 200. These functions will be described further below. As shown in FIG. 15, an external grip 202 is provided for the user to grasp when turning the rotary cap 200. As shown in FIG. 22, the rotary cap 200 has recesses 204 that are formed in a forward face 206 of the rotary cap 200. As shown in FIGS. 14 and 23 through 25, the rotary cap 200 also has an internal thread 208 that engages a spring guide 210.

As shown in FIG. 16, the spring guide 210 is installed on the internal housing 186. Like the stopping mandril 172, the spring guide 210 has internal straight sides 212 that engage the straight sides 188 of the internal housing 186. Thus, the spring guide 210 is prevented from rotating by the internal housing 186, but the spring guide 210 may move axially on the internal housing 186. The spring guide 210 is engaged with the rotary cap 200 with an external thread 214 that engages the internal thread 208 of the rotary cap 200. A series of clutch springs 216 are installed behind the spring guide 210 between a transmission ring gear 218 and the spring guide 210. As shown in FIG. 14, the springs 216 may extend through holes 220 in the gear box housing and may each bias a ball 222 against one of the transmission ring gears 218. The details of this type of clutch will be described further below.

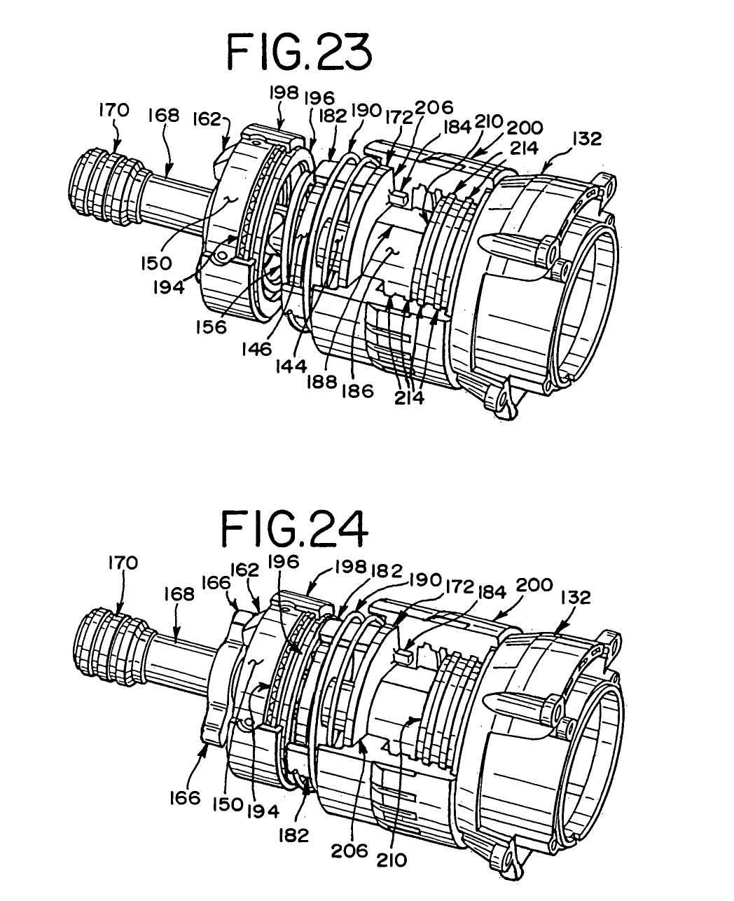

The operation of the mode selector mechanism 130 is now apparent. Referring specifically to FIGS. 23 and 24, but also generally to FIGS. 14 through 22, the impact driver 20 may be operated in at least three different modes. In one mode, the impact driver 20 may operate like a conventional impact driver without a torque limiting clutch as illustrated in FIGS. 23 and 24. In the other modes (described further below), the impact driver 20 may operate like a drill with and without a torque limiting clutch. In FIG. 23, the mode selector mechanism 130 is shown with the rotary cap 200 in the impact mode position. In this position, the rear portions 184 of the stopping mandril 172 are received in the recesses 204 of the rotary cap 200. As a result, the mandril spring 190 forces the stopping mandril 172 rearward. The spring guide 210 is also positioned fully rearward along the threaded engagement 208, 214 between the rotary cap 200 and the spring guide 210. Because the stopping mandril 172 is in a rearward position, the impact member 150 is allowed to move axially rearward and may disengage from the output shaft 168 like a conventional impact driver as described above. In particular, as shown in FIG. 23, at relatively low torque loads, the impact member 150 drives the output shaft 168 through the pawls 162 of the impact member 150 and the arms 166 of the output shaft 168. However, when the output shaft 168 experiences a torque load that is high enough, the impact member 150 compresses the impact member spring 156 and moves rearward. As shown in FIG. 24, this causes the pawls 162 and the arms 166 to disengage from each other. Once disengaged, the impact member 150 continues to rotate due to the continued driving of the motor 140, but the rotation of the output shaft 168 slows or stops. The pawls 162 of the impact member 150 then cross over the arms 166 of the output shaft 168. Once the pawls 162 pass the arms 166, the impact member spring 156 forces the impact member 150 and the pawls 162 forward again to reengage the output shaft 168. When the pawls 162 complete their rotation, the pawls 162 once again come into contact with the arms 166. At this point, the pawls 162 impact the arms 166 and impart a torque pulse to the output shaft 168. The impacts continue until the torque load on the output shaft 168 drops below the capacity of the impact member spring 156 or the user turns off the motor 140. Although the torque coupler described herein is the preferred mechanism for providing torque pulses to the output shaft 168, other torque couplers may also be used.

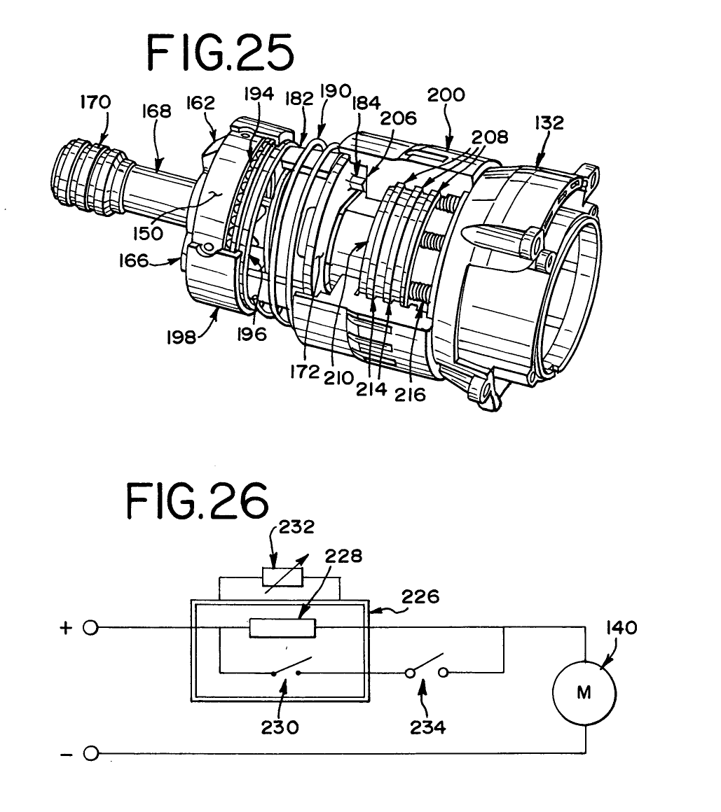

Referring now specifically to FIG. 25, but also generally to FIGS. 14 through 22, the rotary cap 200 may also be positioned in multiple drill modes. In FIG. 25, the rotary cap 200 has been rotated so that the rear portions 184 of the stopping mandril 172 are no longer received by the recesses 204 of the rotary cap 200. Instead, the rear portions 184 of the stopping mandril 172 are pushed forward by the forward face 206 of the rotary cap 200. This pushes the axial arms 182 of the stopping mandril 172 forward so that the mandril arms 182 are adjacent the supporting ring 196 of the impact member 150. As a result, the impact member 150 is prevented from moving rearward, and the pawls 162 are prevented from disengaging from the stopping arms 166. This causes the output torque to be generally smooth without torque pulses regardless of the torque load.

The rotary cap 200 also adjusts the torque capacity of the torque limiting clutch. As shown in FIG. 25, the spring guide 210 is positioned fully forward along the threaded engagement 208, 214 between the rotary cap 200 and the spring guide 210. In this position, the clutch springs 216 are minimally compressed, which represents the lowest clutch setting. However, as the rotary cap 200 is turned, the spring guide 210 is forced rearward by the engagement between the external thread 214 of the spring guide 210 and the internal thread 208 of the rotary cap 200. As a result, the clutch springs 216 are compressed to a greater degree. As with a conventional clutch, the clutch springs 216 press on the balls 222. The balls 222 may engage a series of ramps 224 on one of the ring gears 218 in the transmission. In such an arrangement, torque is generated by the transmission gears as long as the ring gear 218 engaged by the balls 222 does not rotate. The pressure of the clutch springs 216 against the balls 222 and the ring gear ramps 224 prevents the ring gear 218 from rotating. However, when the transmission torque on the ring gear 218 overcomes the pressure applied by the clutch springs 216, the ring gear 218 begins to rotate. As a result, torque is no longer transmitted to the input shaft 144. This type of clutch arrangement is also described in U.S. Pat. No. 5,738,469.

Because the rear portions 184 of the stopping mandril 172 and the recesses 204 of the rotary cap 200 are offset from center as shown in FIGS. 20 and 21, the rotary cap 200 may be rotated nearly a full 360° before the rear portions 184 can become reengaged with the recesses 204. However, the rotation of the rotary cap 200 may be limited less than 360° by a rotational stop or by limiting the range of the threaded engagement 208, 214 between the rotary cap 200 and the spring guide 210. Thus, in the described embodiment, only one position exists in which the rear portions 184 are received by the recesses 204. This is the single position of the rotary cap 200 in which the impact mode is selected. In this position, the clutch springs 216 are fully compressed as shown in FIGS. 23 and 24. As a result, the balls 222 become locked against the ramps 224 of the transmission ring gear 218. Thus, in the impact mode, the clutch is disabled. As the rotary cap 200 is rotated away from the impact mode, a series of drill modes becomes available. The first drill mode position exists directly adjacent the impact mode just described. In this position, the stopping mandril 172 is forced forward as shown in FIG. 25 to prevent disengagement of the impact member 150 and the output shaft 168. The spring guide 210 is also positioned rearward but slightly ahead of the position shown in FIGS. 23 and 24 due to the slight rotation of the rotary cap 200 which forces the spring guide 210 forward slightly. Because the clutch springs 216 are still mostly compressed, the balls 222 remain locked against the transmission ring gear 218. Thus, in this position of the drill mode, generally smooth torque is supplied to the output shaft 168 and the clutch is disabled. As the rotary cap 200 is rotated further, additional drill modes become available with each having a different clutch setting. For example, the second drill mode position exists directly adjacent the first drill mode position. In this position, the stopping mandril 172 remains engaged with the impact member 150 so that generally smooth torque is supplied to the output shaft 168. However, the spring guide 210 is positioned slightly further forward from the first drill mode position. At this point, the clutch springs 216 are relaxed enough to allow the transmission ring gear 218 to move relative to the balls 222 under high torque loads. Thus, the clutch is enabled in the second drill mode position, with the torque setting being the highest clutch setting available. Additional drill mode positions are available by continuing to rotate the rotary cap 200 further. As the rotary cap 200 is rotated further, the stopping mandril 172 remains engaged with the impact member 150 in the remaining drill mode positions so that generally smooth torque is supplied to the output shaft 168. However, in each of the remaining drill mode positions, the spring guide 210 moves increasingly further forward, thereby compressing the clutch springs 216 less with each setting. As shown in FIG. 25, the lowest clutch setting is illustrated. In this position, the spring guide 210 is moved fully forward, and the clutch springs 216 are in their least compressed state. Thus, the clutch setting in this position is the lowest. The settings for the rotary cap 200 described here are only some of the examples that are possible, and other settings may be achieved depending on the particular configuration of the rotary cap 200 and associated components.

Other types of clutches may also be used with the impact driver 20. For example, as shown in FIG. 26, an electronic clutch that may be used is shown. The electronic clutch may be used in place of the mechanical clutch described above if desired. The electronic clutch includes a trigger assembly 226 with an FET 228 and a bypass circuit 230. The FET 228 may be controlled by the trigger switch of the impact driver 20 and controls the speed of the motor 24, 140. The bypass circuit 230 limits the maximum speed of the motor 24, 140. The electronic clutch also includes a torque controller 232 and a microswitch 234 that operate together to provide the desired torque limiting capability. The torque controller 232 may be operatively coupled to the rotary cap 200 or another user actuable setting to limit the torque supplied by the motor 24, 140 based on the user's selected torque setting. Thus, the torque controller 232 may be set so that the motor 24, 140 supplies either high torque to the input shaft 144, low torque, or any setting therebetween. The microswitch 234 disables the torque controller 232 so that the motor 24, 140 supplies maximum torque to the input shaft 144 when the microswitch 234 is in the “on” state. Thus, preferably, the microswitch 234 is in the “on” state during the impact mode and the first drill mode setting in order to disable the torque controller 232. The microswitch 234 is changed to the “off” state in the remaining drill mode settings to enable the torque controller 232 to limit the torque supplied to the input shaft 144 based on the particular torque setting chosen by the user.

While preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. Moreover, the advantages described above are not necessarily the only advantages of the invention, and it is not necessarily expected that all of the described advantages will be achieved with every embodiment of the invention.

We claim:

1. A rotary power tool with a mode selector mechanism for selecting between an impact mode and a drill mode, the rotary power tool comprising:
a housing;
a motor oriented in the housing;
an input shaft rotatably mounted to the housing and driven by the motor;
an output shaft rotatably mounted to the housing and operatively coupled to and driven by the input shaft;
a torque responsive coupler connecting the input shaft to the output shaft such that in an impact mode upon experiencing a torque applied to the output shaft that exceeds a predetermined amount of torque causing the output shaft to rotate at a speed less than that of the input shaft, the coupler retracts for decoupling the input shaft and output shaft, the coupler including a biasing member for re-coupling the input shaft and the output shaft as the input shaft continues to rotate at a speed greater than that of the output shaft, the coupler having a mass sufficient to apply an impact to the output shaft upon re-coupling that generates an output torque exceeding the predetermined amount of torque; and
a stopping member shiftable by a user between a first orientation wherein the coupler is free to move in the impact mode, and positionable in a second orientation wherein the stopping member prevents the coupler from retracting in a drill mode thereby maintaining a connection of the input shaft and the output shaft.

2. The rotary power tool of claim 1, wherein the stopping member is further defined as a translatable arm having:
a first end operably connected to an actuation member shiftably connected to the housing,
an intermediate region slidably cooperating with the housing, and
a second end,
wherein shifting of the actuation member to a first orientation actuates the arm first end relative to the housing causing the intermediate region to slide relative to the housing, consequently retracting the arm second end from the path of retraction of the coupler, and shifting of the actuation member in a second direction extends the arm second end into the path of retraction of the coupler.

3. The rotary power tool of claim 1, wherein the stopping member is further defined as a pair of diametrically opposed translatable arms, each having:
a first end operably connected to an actuation member shiftably connected to the housing,
an intermediate region slidably cooperating with the housing, and
a second end,
wherein shifting of the actuation member to a first orientation actuates the arm first ends relative to the housing causing the intermediate regions to slide relative to the housing, consequently retracting the arm second ends from the path of retraction of the coupler, and shifting of the actuation member in a second direction extends the arm second ends into the path of retraction of the coupler.

4. The rotary power tool of claim 1, wherein the stopping member is axially moveable relative to the coupler, the stopping member comprising an axially extending arm engaging the coupler in the second orientation to prevent the coupler from retracting, the axially extending arm moving axially away from the coupler in the first orientation to allow the coupler to move freely.

5. The rotary power tool of claim 4, wherein the stopping member is rotationally fixed to the housing and is axially moveable relative to the housing, the stopping member further comprising an axially extending portion abutting a face of a rotary cap in the second orientation and received by a recess in the face of the rotary cap in the first orientation, the stopping member thereby moving axially toward the coupler in the second orientation to prevent the coupler from retracting and moving axially away from the coupler in the first orientation to allow the coupler to move freely.

6. The rotary power tool of claim 1, further comprising a thrust bearing oriented between the coupler and the stopping member to provide thrust support therebetween.

7. The rotary power tool of claim 6, wherein the thrust bearing is rotatably affixed to the coupler.

8. The rotary power tool of claim 1, wherein the stopping member is operatively coupled to a rotary cap that is pivotally mounted to the housing so that a user may select the impact or drill mode by rotating the cap.

9. The rotary power tool of claim 8, wherein the stopping member is further defined as an arcuate arm having:
a first end pivotally connected to the rotary cap about an axis radially offset from the output shaft,
an intermediate region having an arcuate slot formed therethrough for receiving a longitudinal pin mounted to the housing at a radially offset orientation from the output shaft, and
a second end,
wherein rotation of the rotary cap in a first direction rotationally displaces the arcuate arm first end relative to the housing causing the arcuate slot to slide about the pin, consequently shifting the arcuate arm second end from the path of retraction of the coupler, and rotation of the rotary cap in a second direction extends the arcuate arm second end into the path of retraction of the coupler.

10. The rotary power tool of claim 8, wherein the stopping member is further defined as a pair of diametrically opposed arcuate arms, each having:
a first end pivotally connected to the rotary cap about an axis radially offset from the output shaft,
an intermediate region having an arcuate slot formed therethrough for receiving a longitudinal pin mounted to the housing at a radially offset orientation from the output shaft, and
a second end,
wherein rotation of the rotary cap in a first direction rotationally displaces the arcuate arm first ends relative to the housing causing the arcuate slots to each slide about the respective pins, consequently shifting the arcuate arm second ends from a path of retraction of the coupler, and rotation of the rotary cap in the second direction extends the arcuate arm second ends into the path of retraction of the coupler.

11. The rotary power tool of claim 8, further comprising an adjustable clutch operably connecting the motor and the input shaft to regulate torque translated therethrough;
wherein the rotary cap cooperates with the adjustable clutch for permitting adjustment of a regulated torque.

12. The rotary power tool of claim 11, wherein the rotary cap is adjustable between a plurality of rotary positions including:
a first position wherein the stopping member is shifted into the first orientation, thus selecting the impact mode, and the adjustable clutch provides direct drive from the motor to the input shaft,
a second position wherein the stopping member is shifted into the second orientation, thus selecting the drill mode, and the adjustable clutch provides direct drive from the motor to the input shaft, and
a plurality of other positions wherein the stopping member is retained in the second orientation, corresponding with the drill mode, and the adjustable clutch provides torque-limited drive from the motor to the input shaft, the torque-limit being a function of the radial orientation of the rotary cap.

13. A rotary power tool with a mode selector mechanism for selecting between an impact mode and a drill mode, the rotary power tool comprising:
a housing;
a motor oriented in the housing;
an input shaft rotatably mounted to the housing and driven by the motor, the input shaft having a first cam configuration;
a hammer block having a corresponding second cam configuration cooperating with the first cam configuration of the input shaft, such that the hammer block is connected to the input shaft and has a limited range of rotational and axial movement relative to the input shaft, the hammer block having at least one forward extending projection;
an output shaft rotatably mounted to the housing at an orientation forward of the hammer block, the output shaft having at least one radially extending arm for engagement with the hammer block projection;
a spring cooperating with the input shaft and the hammer block to bias the hammer block to a forward orientation and engage the hammer block projection with the output shaft arm; and
at least one stopping member selectively positionable by a user in a first orientation wherein the hammer block is free to move in an impact mode, and positionable in a second orientation within a path of axial travel of the hammer block to maintain an engagement of the hammer block and the output shaft in a drill mode.

14. The rotary power tool of claim 13, wherein the stopping member is further defined as a translatable arm having:
a first end operably connected to an actuation member shiftably connected to the housing,
an intermediate region slidably cooperating with the housing, and
a second end,
wherein shifting of the actuation member to a first orientation actuates the arm first end relative to the housing causing the intermediate region to slide relative to the housing, consequently retracting the arm second end from the path of axial travel of the hammer block, and shifting of the actuation member in a second direction extends the arm second end into the path of axial travel of the hammer block.

15. The rotary power tool of claim 14, wherein the stopping member is operatively coupled to a rotary cap that is pivotally mounted to the housing so that a user may select the impact mode or the drill mode by rotating the cap.

16. The rotary power tool of claim 13, wherein the stopping member is further defined as a pair of diametrically opposed translatable arms, each having:
a first end operably connected to an actuation member shiftably connected to the housing,
an intermediate region slidably cooperating with the housing, and
a second end,
wherein shifting of the actuation member to a first orientation actuates the arm first ends relative to the housing causing the intermediate regions to slide relative to the housing, consequently retracting the arm second ends from the path of axial travel of the hammer block, and shifting of the actuation member in a second direction extends the arm second ends into the path of axial travel of the hammer block.

17. The rotary power tool of claim 13, wherein the stopping member is axially moveable relative to the hammer block, the stopping member comprising an axially extending arm engaging the hammer block in the second orientation to maintain the engagement of the hammer block and the output shaft, the axially extending arm moving axially away from the hammer block in the first orientation to allow the hammer block to move freely.

18. The rotary power tool of claim 17, wherein the stopping member is rotationally fixed to the housing and is axially moveable relative to the housing, the stopping member further comprising an axially extending portion abutting a face of a rotary cap in the second orientation and received by a recess in the face of the rotary cap in the first orientation, the stopping member thereby moving axially toward the hammer block in the second orientation to maintain the engagement of the hammer block and the output shaft and moving axially away from the hammer block in the first orientation to allow the hammer block to move freely.

19. The rotary power tool of claim 13, further comprising a thrust bearing oriented between the hammer block and the stopping member to provide thrust support therebetween.

20. The rotary power tool of claim 19, wherein the thrust bearing is rotatably affixed to the hammer block.

21. A rotary power tool comprising:
a housing;
a motor oriented in the housing;
an input shaft rotatably mounted to the housing and driven by the motor;
an impact member coupled to the input shaft, the impact member being rotatably driven by the input shaft, the impact member comprising a driving portion;
an output shaft rotatably mounted to the housing, the output shaft comprising a driven portion;
a spring biasing the driving portion of the impact member and the driven portion of the output shaft toward each other, the driving portion and the driven portion thereby being engageable to drive the output shaft with the input shaft through the impact member;
a stopping member moveable between a first position and a second position, wherein the first position allows the driving portion and the driven portion to disengage in response to an output torque, the spring biasing the driving portion and the driven portion to reengage after being disengaged and thereby producing a torque impulse to the output shaft, and the second position prevents the driving portion and the driven portion from disengaging, the output shaft thereby supplying generally smooth torque without producing the torque impulse; and
a mode selector operatively coupled to the stopping member and being moveable relative to the housing between at least a first selected position and a second selected position, the stopping member being responsive to the mode selector, wherein the stopping member moves to the first position when a user moves the mode selector to the first selected position and the stopping member moves to the second position when a user moves the mode selector to the second selected position.

22. The rotary power tool of claim 21, further comprising a clutch limiting a torque supplied by the input shaft, the mode selector being operatively coupled to the clutch and being moveable between at least the first selected position, the second selected position and a third selected position, wherein the clutch is prevented from limiting the torque supplied by the input shaft when the mode selector is in the first selected position and in the second selected position, and the clutch limits the torque supplied by the input shaft when the mode selector is in the third selected position.

23. The rotary power tool of claim 21, wherein the stopping member is axially moveable relative to the impact member, the stopping member comprising an axially extending arm engaging the impact member in the second position to prevent the driving portion and the driven portion from disengaging, the axially extending arm moving axially away from the impact member in the first position to allow the driving portion and the driven portion to disengage.

24. The rotary power tool of claim 23, wherein the stopping member is rotationally fixed to the housing and is axially moveable relative to the housing, the stopping member further comprising an axially extending portion abutting a face in the second position and received by a recess in the face in the first position, the stopping member thereby moving axially toward the impact member in the second position to prevent the driving portion and the driven portion from disengaging and moving axially away from the impact member in the first position to allow the driving portion and the driven portion to disengage.

25. The rotary power tool of claim 24, wherein the stopping member comprises more than one axially extending portion and the face comprises more than one corresponding recess, each of the axially extending portions and the corresponding recesses being disposed at different radial locations from an axis of rotation, whereby upon rotation of the face each of the axially extending portions are received only by a corresponding recess.

26. The rotary power tool of claim 24, wherein the mode selector is rotatable relative to the housing and the face and the recess are formed in an interior portion of the mode selector.

27. The rotary power tool of claim 26, wherein the input shaft and the output shaft are axially fixed relative to the housing, the impact member is axially moveable upon the input shaft, the driven portion of the output shaft comprises an arm extending radially outward from the output shaft, the driving portion of the impact member comprises a pawl extending axially forward from the impact member, and the spring is disposed to bias the impact member and the pawl forward toward the arm of the output shaft.

28. The rotary power tool of claim 27, wherein the stopping member comprises more than one axially extending portion and the mode selector comprises more than one corresponding recess, each of the axially extending portions and the corresponding recesses being disposed at different radial locations from an axis of rotation, whereby upon rotation of the mode selector each of the axially extending portions are received only by a corresponding recess.

29. The rotary power tool of claim 28, further comprising a stopping member spring disposed between a forward surface of the stopping member and the housing, the stopping member spring thereby biasing the stopping member rearward away from the impact member, and a bearing disposed between the axially extending arm and the impact member, the bearing providing thrust support between the stopping member and the impact member in the second position and the third position.

30. The rotary power tool of claim 29, wherein the spring is disposed between a plate fixed to the input shaft and a rear side of the impact member.

31. The rotary power tool of claim 30, further comprising a clutch limiting a torque supplied by the input shaft, the mode selector being operatively coupled to the clutch and being moveable between at least the first selected position, the second selected position and a third selected position, wherein the clutch is prevented from limiting the torque supplied by the input shaft when the mode selector is in the first selected position and in the second selected position, and the clutch limits the torque supplied by the input shaft when the mode selector is in the third selected position, wherein the mode selector comprises a first helical thread and the clutch comprises a spring guide with a second helical thread, the spring guide being rotationally fixed to the housing and being axially moveable relative to the housing, whereby rotation of the mode selector causes the spring guide to move axially relative to the housing thereby changing a pressure on a clutch spring and changing a torque limit of the clutch.

31. The rotary power tool of claim 21, wherein the stopping member comprises an axial arm extending forward toward the impact member, and a straight side engaging a straight side of a housing, the stopping member being rotationally fixed to the housing and being axially moveable relative to the housing, and further comprising a bearing disposed between the axial arm of the stopping member and a rear side of the impact member, the axial arm moving forward toward the impact member in the second position and being disposed adjacent thereto, the axial arm thereby preventing the driving portion and the driven portion from disengaging and the bearing rotating between the axial arm and the impact member, the axial arm moving rearward from the impact member in the second position and being disposed away therefrom, the axial arm thereby allowing the driving portion and the driven portion to disengage and the bearing not rotating between the axial arm and the impact member.

32. The rotary power tool of claim 31, further comprising a stopping member spring biasing the stopping member rearward from the impact member, the stopping member further comprising an axial portion extending rearward toward the mode selector, the axial portion being engaged by the mode selector, the mode selector thereby forcing the axial arm forward against the stopping member spring in the second position and allowing the stopping member spring to move the axial arm rearward in the first position.

33. The rotary power tool of claim 32, wherein the mode selector further comprises a forward face and a recess in the face, the axial portion of the stopping member engaging the face in the second position and received in the recess in the first position.

34. The rotary power tool of claim 32, wherein the mode selector comprises a first surface and a second surface, the first surface engaging the stopping member in the first position thereby allowing the driving member and the driven member to disengage, and the second surface engaging the stopping member in the second position thereby preventing the driving member and the driven member from disengaging, the mode selector further comprising a first thread engaging a second thread of a spring guide, the spring guide being rotationally fixed to the housing and being axially moveable relative thereto, wherein the axial portion of the stopping member changes from engaging the first surface to engaging the second surface upon rotation of the mode selector and the spring guide moves axially relative to the housing to engage a clutch upon rotation of the mode selector.

35. The rotary power tool of claim 34, wherein the first surface is a recess, the second surface is a face, the first thread is an internal thread, and the second thread is an external thread.

36. The rotary power tool of claim 21, wherein the mode selector comprises a first surface and a second surface, the first surface engaging the stopping member in the first position thereby allowing the driving member and the driven member to disengage, and the second surface engaging the stopping member in the second position thereby preventing the driving member and the driven member from disengaging, the mode selector further comprising a first thread engaging a second thread of a spring guide, the spring guide being rotationally fixed to the housing and being axially moveable relative thereto, wherein the axial portion of the stopping member changes from engaging the first surface to engaging the second surface upon rotation of the mode selector and the spring guide moves axially relative to the housing to engage a clutch upon rotation of the mode selector.

37. The rotary power tool of claim 36, wherein the first surface is a recess, the second surface is a face, the first thread is an internal thread, and the second thread is an external thread.
